(19) United States
(12) Patent Application Publication
(10) Pub. No.: US 2014/0365380 A1
(43) Pub. Date: Dec. 11, 2014

(54) Method and System for Monitoring the Health Status of Electronic Appliances

(71) Applicant: Tata Consultancy Services Limited, Maharashtra (IN)

(72) Inventors: Subrata Kolay, Kolkata (IN); Ranjan Dasgupta, Kolkata (IN); Arpan Pal, Kolkata (IN)

(21) Appl. No.: 14/374,009

(22) PCT Filed: Jan. 21, 2013
(86) PCT No.: PCT/IN2013/000042

§ 371 Date: Jul. 23, 2014

(30) Foreign Application Priority Data
Jan. 23, 2012 (IN) 222/MUM/2012

(51) Int. Cl. G06Q 10/00

(52) U.S. Cl. CPC G06Q 10/20
USPC 705/305

(57) ABSTRACT

A method and system is provided for monitoring the health status of electronic appliances. Particularly, the disclosure provides a method and system for registering an electronic appliance with a diagnostic server, sampling a transient and steady current signature of the electronic appliance by a home energy gateway, uploading said sampled transient and steady current signature to the diagnostic server for further analysis, diagnosing a health status of said electronic appliance based on the analyzed transient and steady current signature, and reporting a diagnosed health status of said electronic appliances to a user.

### FIELD OF THE DISCLOSURE

The present disclosure relates to social networking and internet. Particularly the disclosure provides a method and system for creating an intelligent social network between a plurality of devices participating in a social network over internet

### BACKGROUND OF THE DISCLOSURE

With the advent of computers, calculating and predicting efforts of human being were taken up by computers. With the advent of the online social networks, significant part of social life of a human being was taken up by online social networks based on the computing and communicating devices. The social networking platforms are used for participation and interaction among people.

Social networking platform available at this point of time, allows users to upload and share their personal or professional updates for their peer group to view and comment. Social networking platforms such as Facebook, Orkut, Twitter, Myspace, Friendster allows users to engage in virtual activities like games, chats, watching of videos in a virtual social community. However, most of these updates are generated by users only by inputting data through a physical computing device and very little of their daily status updates are enhanced by intelligent devices around them. User may find that they spend a disproportionate amount of time in maintaining their virtual lives, which eventually start hampering their real lives.

Apart from the user participating in social networking platform, devices participating in social networking platform are employed to generate a lot of data pertaining to users using said social networking platform and that can augment information in a social network. In the current scenario, there is no intent model for devices in existing social networks and also there is no framework for devices to augment existing human social networks.

Thus, in the light of the above mentioned background, it is evident that there is a need for a solution that can create an intelligent social network of devices over internet, which can associate social behavior with non human objects and things such as devices participating in social networking platform.

### OBJECTIVES OF THE DISCLOSURE

In accordance with the present disclosure, the primary objective is to provide a method and system for creating an intelligent social network between a plurality of devices participating in a social network over internet

Another objective of the disclosure is to provide a method and system for detecting user intent of first device by one or more subsequent devices based on pre-defined parameters.

Another objective of the disclosure is to provide a method and system for detecting intent of user of a first device by one or more of subsequent devices out of the plurality of devices based on one or more pre-defined parameter.

Another objective of the disclosure is to provide a method and system for detecting a match between the one or more common intent of the user of the first device and the one or more users of the one or more subsequent devices based on said one or more pre-defined parameter.

Another objective of the disclosure is to provide a method and system for transmitting information pertaining to the one or more detected common intent of the user of the first device to one or more subsequent devices by said first device.

Another objective of the disclosure is to provide a method and system for enabling communication and formation of intelligent social network between the first device and the one or more of subsequent devices.

Yet another objective of the disclosure is to provide a method and system for creating and maintaining device profiles over internet, for participating in the internet based social network of devices.

### SUMMARY OF THE DISCLOSURE

Before the present methods, systems, and hardware enablement are described, it is to be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

The present disclosure provides a method and system for creating an intelligent social network between a plurality of devices participating in a social network over the Internet.

In an embodiment of the disclosure a method and system is provided for detecting user intent of a user of a first device with one or more subsequent devices based on pre-defined parameters.

In an embodiment of the disclosure a method and system is provided for detecting intent of a user of a first device with one or more of subsequent devices out of the plurality of devices based on one or more pre-defined parameter.

In an embodiment of the disclosure a method and system is provided for detecting a match between the detected intent of the user of the first device and one or more users of the one or more subsequent devices based on said one or more pre-defined parameter.

In an embodiment of the disclosure a method and system is provided for transmitting a quantity of information pertaining to the one or more detected intent of the user of the first device to one or more subsequent devices by said first device.

In an embodiment of the disclosure a method and system is provided for enabling communication and formation of an intelligent social network between the first device and the one or more of subsequent devices.

In an embodiment of the disclosure a method and system is provided for creating and maintaining device profiles over the Internet, for participating in the Internet based social network of devices.

In an embodiment of the disclosure a method and system is provided for creating and maintaining device profiles over the Internet, for participating in the Internet based social network of devices.

In an embodiment of the disclosure a system is provided for creating an intelligent social network of devices over the Internet, wherein the system comprises a first device (202) and one or more of subsequent devices (204) adapted to detect a match between one or more common intent of the user of the first device (202) and the one or more users of the one or more subsequent devices (204) based on one or more pre-defined parameter and wherein information pertaining to the one or more detected common intent of the user of the first device (202) is transmitted to one or more subsequent devices (204) by said first device (202) using representational state transfer (REST) API (210); a residential gateway (208) running on a web server hosted on the Internet, wherein the residential gateway facilitates communication to the web server in cases of constrained sensors; and a database adapted to store corresponding values of said one or more pre-defined parameter and a social profile of the plurality of devices participating in the intelligent social network (220).

The above said method and system are preferably for creating an intelligent social network of devices over the Internet but also can be used for many other applications.

### BRIEF DESCRIPTION OF THE DRAWINGS

The foregoing summary, as well as the following detailed description of preferred embodiments, are better understood when read in conjunction with the appended drawings. For the purpose of illustrating the disclosure, there is shown in the drawings exemplary constructions of the disclosure; however, the disclosure is not limited to the specific methods and system disclosed. In the drawings:

FIG. 1: shows a flow diagram of the process for creating intelligent social network of devices

FIG. 2: shows a block diagram of the process for creating intelligent social network of devices

FIG. 3: shows a social network graph for a carpool application intelligent social network of devices

### DETAILED DESCRIPTION OF THE DISCLOSURE

Some embodiments of this disclosure, illustrating all its features, will now be discussed in detail.

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

The disclosed embodiments are merely exemplary of the disclosure, which may be embodied in various forms.

The present application provides a method for creating an intelligent social network (220) between a plurality of devices participating in a social network over internet; the method comprises processor implemented steps of:
a. detecting intent of at least one user of a first device (202) by one or more of subsequent devices (204) out of the plurality of devices based on one or more pre-defined parameter;
b. detecting a match between the one or more common intent of the user of the first device (202) and the one or more users of the one or more subsequent devices (204) based on said one or more pre-defined parameter;
c. transmitting information pertaining to the one or more detected common intent of the user of the first device (202) to one or more subsequent devices (204) by said first device (202); and
d. enabling communication and formation of intelligent social network (220) between the first device (202) and the one or more of subsequent devices (204).

The present application provides a system for creating an intelligent social network (220) between a plurality of devices participating in a social network over internet, wherein the system comprising of:
a. a first device (202) and one or more of subsequent devices (204) adapted to detect a match between one or more common intent of the user of the first device (202) and the one or more users of the one or more subsequent devices (204) out of the plurality of devices based on one or more pre-defined parameter and further transmitting information pertaining to the one or more detected common intent of the user of the first device (202) to one or more subsequent devices (204) by said first device (202) using representational state transfer (REST) API (210);
b. a residential gateway (208) running on a web server hosted on the internet and facilitating communication to the web server in cases of constrained devices/sensors; and
c. a database adapted to store corresponding values of said one or more pre-defined parameter and social profile of the plurality of devices participating in the social network (220).

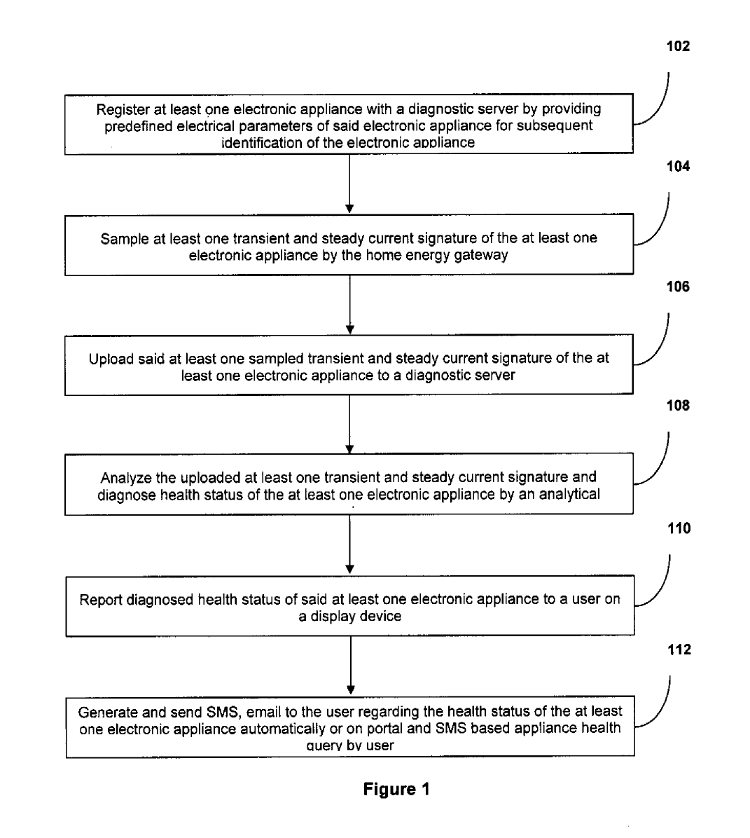

Referring to FIG. 1 is a flow diagram of the process for creating intelligent social network of devices.

The process starts at the step 102, intent of at least one user of a first device is detected by one or more of subsequent devices out of the plurality of devices based on one or more pre-defined parameters. At the step 104, a match is detected between the one or more common intent of the user of the first device and the one or more users of the one or more subsequent devices based on said one or more pre-defined parameters. At the step 106, information pertaining to the one or more detected common intent of the user of the first device is transmitted to one or more subsequent devices by said first device. The process ends at the step 108, communication and formation of intelligent social network is enabled between the first device and the one or more of subsequent devices.

In an embodiment of the disclosure, in the social networking platforms, people participate whereas devices do not. Devices can generate a lot of data that can augment information in a social network. The devices are used to detect user activity and allow other users to interact using that information, thereby creating an immersion of real and virtual worlds. It also discusses the enabling technology in creating and maintaining a social network of devices. The present disclosure allows devices to discover and update user's context like presence as they move to different locations, real life activities such as watching television and moods. It also depicts how people react to such updates and thereby interact with each other. Considering the example of television, the television may tweet the information pertaining to the program on Twitter, which the user is watching. The Tweet informs user's followers on Tweeter and friends. When user's friends or followers are watching the same program or channel, they become “closer” friends in the virtual world and your “trust” in them automatically upgrades.

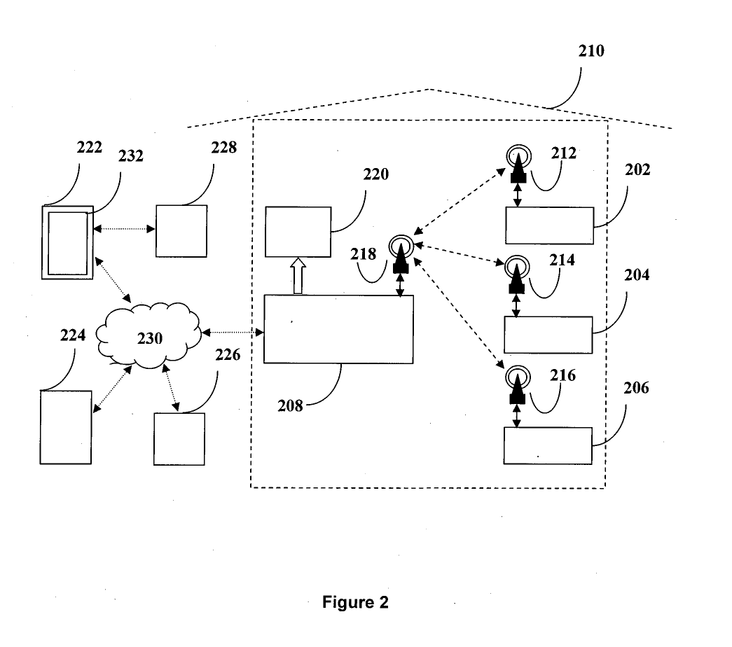

Referring to FIG. 2 is a block diagram of the process for creating intelligent social network of devices.

In an embodiment of the disclosure, the system for creating intelligent social network of devices comprises of a First Device (202), a Subsequent Device (204), a Residential gateway (208), an Representational State Transfer (REST) API (210), a Feedback (CE-HTML) (212) application, a Home boundary (216), an Oauth (218) and a social network (220).

In an embodiment of the disclosure, the method is provided for creating intelligent social network of devices, wherein the plurality of devices are selected from the group comprising but not limited to sensing devices, transmitting devices, receiving devices, computing devices, or mobile communication devices.

In an embodiment of the disclosure, the method is provided for creating intelligent social network of devices, wherein the an intent of at least one user of a First Device (202) is detected by one or more of Subsequent Devices (204) out of the plurality of devices based on one or more pre-defined parameters. The pluralities of devices are also enabled to update user context using common intent of the users. The one or more pre-defined parameter is selected from the group comprising of time, user activity, and repetition of user activity or historical data and further stored in a database. The data pertaining to the one or more pre-defined parameter is being collected from sensors from the group comprising of GPS, GPRS or RFIDs.

A match is detected between the one or more common intent of the user of the First Device (202) and the one or more users of the one or more Subsequent Devices (204) based on said one or more pre-defined parameters. Information pertaining to the one or more detected common intent of the user of the First Device (202) is then transmitted to one or more Subsequent Devices (204) by said First Device (202) enabling communication and formation of intelligent social network (220) between the First Device (202) and the one or more of Subsequent Devices (204).

In an embodiment of the disclosure, the system for creating intelligent social network of devices, wherein the First Device (202), the Subsequent Device (204) uses representational state transfer (REST) API (210) to talk to the Residential gateway (208) running on a web server. The Subsequent Device (204) may support a Feedback (CE-HTML) (212) application to display the XHTML responses. The Subsequent Device (204) is adapted to receive the HTTP response feedback to request sent via the representational state transfer (REST) API (210) by one or more subsequent devices (204) using consumer electronics—hyper text markup language (CE-HTML) (212) application to display the XHTML responses from the residential gateway (208) running on the web server. The social networking data of the first device (202) and the subsequent devices (204) is obtained using an open authorization (Oauth) (218) adapted to connect to the social network (220) via the Residential gateway (208) across the Home Boundary (216).

In an embodiment of the disclosure, the method is provided for creating and maintaining social profile of the plurality of devices participating in the social network (220) using ‘device identification’ of the devices and further stored in the database, wherein the social data is stored in a social graph database Neo4J and is maintained in PostGIS. The social profile of the plurality of devices participating in the social network (220) is obtained by auto analyzing the historical behavior of the plurality of devices or by common intent which is independent of historical data.

### WORKING EXAMPLE OF THE DISCLOSURE

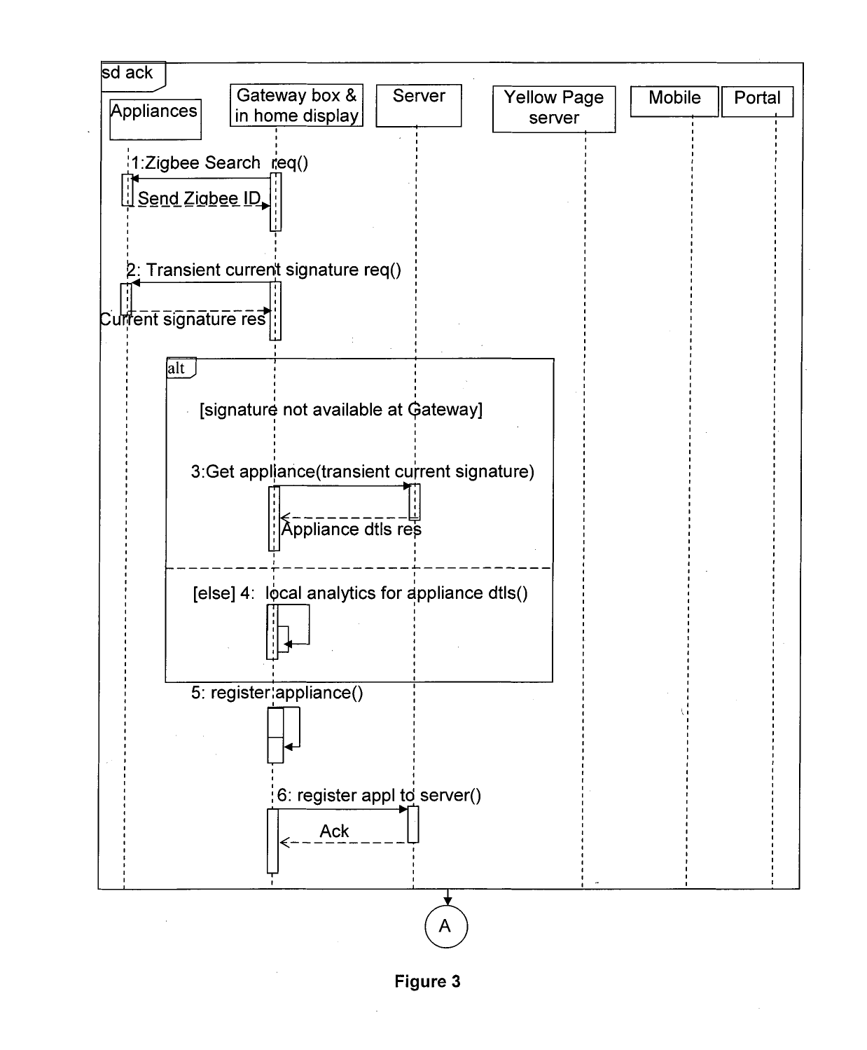

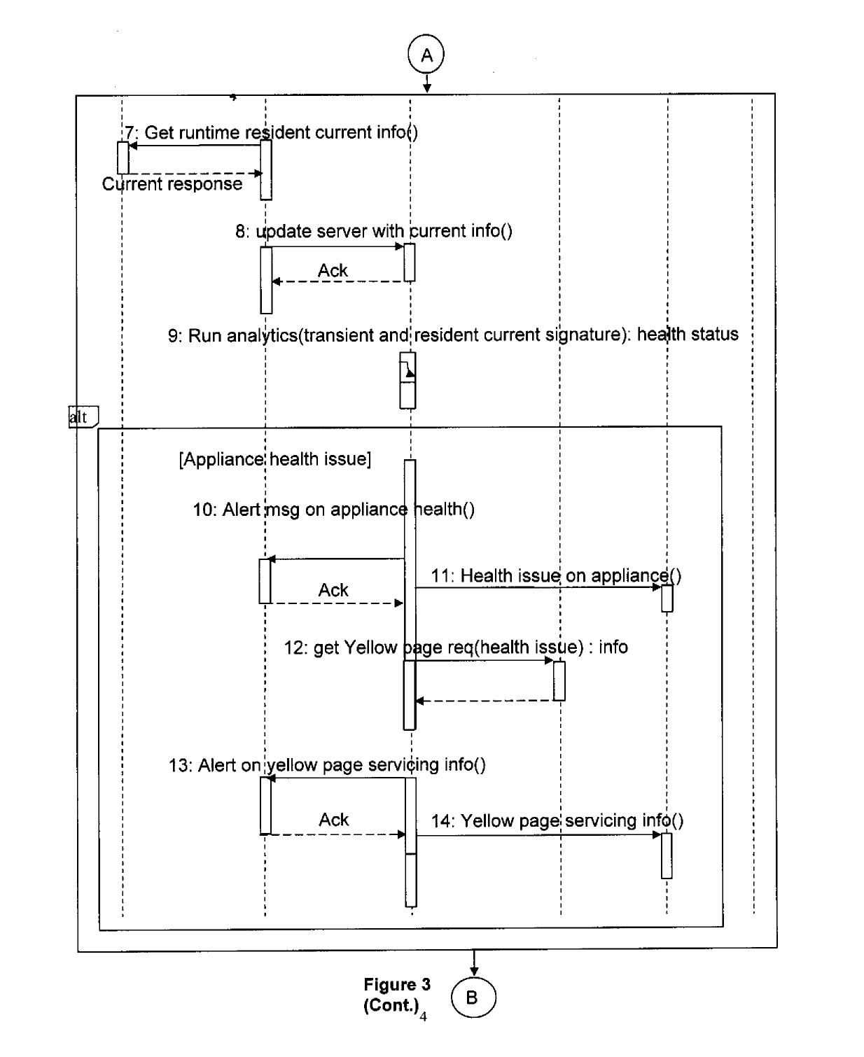

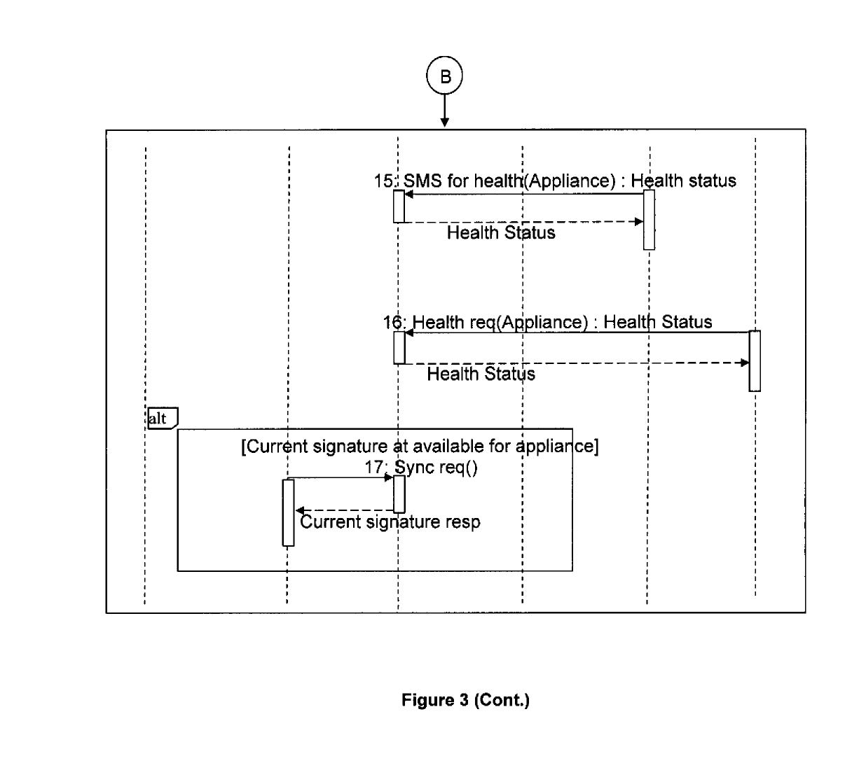

Referring to FIG. 3 is a social network graph for a carpool application intelligent social network of devices.

In an embodiment of the disclosure, the method and system for creating intelligent social network of devices, wherein certain devices augment a person's social network, comprises of a Person A (310), a Person A's GPS sensor (312), a Person A's mobile phone (314), a Person B (320), a Person B's GPS sensor (322), a Person C (330), a Person C's GPS sensor (332), a Person C's accelerometer (334), a Person D (340), and Person D's GPS sensor (342).

In an embodiment of the disclosure, multiple users using different automobiles for commuting along a common path on a regular basis may socially connect due to common intent of automobile pooling such as car pooling wherein the automobile is a car. The cars themselves find potential car pool buddies and notify the owners using cars. For example, cars on the road may be able to cache the Wifi MAC id of the broadcasting cars in radio range. Over a week, the cache consists of those cars Wifi MAC ids which have been encountered most often which may be of potential social connect. These cars may be sent friend requests, which the owners may review and accept if required, or the cars may autonomously form friends. Once the communication is established, these MAC ids, owners' mobile phone, GPS sensor and accelerometer will be traced regularly to extrapolate the routes of the cars, such as the Person A's mobile phone (314) communicates with the Person A's GPS sensor (312) and Person C's accelerometer (334) along with the social network of people involved to list of the possible carpool buddies for a person needing a ride. Once the routes are stabilized or a pattern is detected, the same is matched with owner's car route patterns for a match. Then, social identities of the owners are automatically compared to measure their social distance in online social networks. If that is below the acceptable threshold of risk (such as 2^{nd} degree friends may be the threshold), the matched route is suggested for potential carpool to the cars owners for review and necessary action.

The methodology and techniques described with respect to the exemplary embodiments can be performed using a machine or other computing device within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The machine may include a processor (e.g., a central processing unit (CPU), a graphics processing unit (GPU, or both), a main memory and a static memory, which communicate with each other via a bus. The machine may further include a video display unit (e.g., a liquid crystal displays (LCD), a flat panel, a solid state display, or a cathode ray tube (CRT)). The machine may include an input device (e.g., a keyboard) or touch-sensitive screen, a cursor control device (e.g., a mouse), a disk drive unit, a signal generation device (e.g., a speaker or remote control) and a network interface device.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

1. A method for reporting and monitoring health status of a plurality of electronic appliances, wherein said plurality of electronic appliances is communicatively coupled with a home energy gateway over a local area network, said method comprises steps of:
a. registering at least one electronic appliance of the plurality of electronic appliances with a diagnostic server by providing predefined electrical parameters of said at least one electronic appliance using a widget-based graphical user interface through said home energy gateway;
b. sampling at least one transient and steady current signature of the at least one electronic appliance by the home energy gateway and uploading said at least one sampled transient and steady current signature of the at least one electronic appliance to the diagnostic server by said home energy gateway over the Internet;
c. analyzing the uploaded at least one transient and steady current signature of the at least one electronic appliance;
d. diagnosing health status of said at least one electronic appliance based on the analyzed at least one transient and steady current signature of the at least one electronic appliance by the diagnostic server; and
e. reporting a diagnosed health status of said at least one electronic appliances to a user on a display device with the diagnostic server over the Internet.

2. The method as claimed in claim 1, wherein the uploaded at least one transient and steady current signature of the at least one electronic appliance is analyzed and the diagnosed health status of said electronic appliance is diagnosed based on the at least one analyzed transient and steady current signature of the at least one electronic appliance by an analytical engine running on the diagnostic server.

3. The method as claimed in claim 1, wherein the diagnosed health status of said at least one electronic appliances is reported to the user on the display device using a web portal.

4. The method as claimed in claim 1, wherein the plurality of electronic appliances are communicatively coupled with the home energy gateway over the local area network using communication protocols selected from the group consisting of: ZigBee, NFCs, and Serial and Bluetooth.

5. The method as claimed in claim 1, wherein the at least one transient and steady current signature of the at least one electronic appliance is pre-stored as a reference in a database connected with the diagnostic server for identifying the at least one electronic appliance intelligently while registering said at least one electronic appliance.

6. The method as claimed in claim 5, further comprising searching and locating the at least one pre-stored transient and steady current signatures of the at least one electronic appliance on the home energy gateway for identifying a new electronic appliance of the at least one electronic appliance intelligently while registering said new electronic appliance.

7. The method as claimed in claim 6, further comprising contacting the diagnostic server to retrieve information pertaining to the at least one transient and steady current signatures for the new electronic appliance when the at least one transient and steady current signatures for the at least one electronic appliance is not located on the home energy gateway.

8. The method as claimed in claim 1, wherein the predefined electrical parameters of said at least one electronic appliance further comprises at least one of: electric current and voltage rating.

9. (canceled)

10. The method as claimed in claim 1, wherein the registered at least on electronic appliances is continuously scanned by the home energy gateway, wherein the home energy gateway is notified upon turning on the at least one electronic appliance for sampling the at least one transient and steady current signature of the at least one electronic appliance.

11. The method as claimed in claim 1, wherein the at least one transient and steady current signature of the electronic appliance further comprises at least one transient current signature and at least one steady current signature, wherein the at least one transient current signature is sampled and uploaded to the diagnostic server by the home energy gateway every time upon turning on the at least one electronic appliance wherein the at least one transient current signature of the electronic appliance is sampled and uploaded at high frequency to determine the subtle deviation of at least one characteristic of the at least one electronic appliance, and wherein the at least one steady current signature of the at least one electronic appliance is sampled and uploaded to the diagnostic server by the home energy gateway at periodic, user-defined time intervals.

12. The method as claimed in claim 1, wherein the uploaded at least one transient and steady current signature of the at least one electronic appliance is analyzed by comparing the uploaded at least one transient and steady current signature of the electronic appliance with the predefined electrical parameters of said at least one electronic appliance.

13. The method as claimed in claim 1, wherein the diagnosed health status of said at least one electronic appliance comprises information pertaining to tolerable anomaly in at least one of a transient and a steady current signature of the uploaded at least one transient and steady current signature.

14. The method as claimed in claim 1, further comprises of fetching contact details of service center of the said electronic appliances by the diagnostic server by connecting to a yellow page server over the Internet and pushing the fetched contact details to the home energy gateway for further displaying on the display device.

15. (canceled)

16. (canceled)

17. The method as claimed in claim 1, further comprises generating and sending SMS or email to the user the diagnosed health status of the electronic appliance.

18. (canceled)

19. The method as claimed in claim 1, further comprising sending a request from a mobile communication device of the user to the diagnostic server for a current health status of said at least one electronic appliance.

20. (canceled)

21. A system for reporting and monitoring a health status of a plurality of electronic appliances, the system comprising of:
a home energy gateway adapted to facilitate registration of at least one electronic appliance out of the plurality of electronic appliances with a diagnostic server, wherein predefined electrical parameters of said at least one electronic appliance is provided to the diagnostic server using a widget-based graphical user interface of said home energy gateway;
at least one sampled transient and steady current signature of the at least one electronic appliance, wherein the at least one sampled transient and steady current signature of the electronic appliance is uploaded to the diagnostic server over the Internet;
a. a diagnosed health status of the at least one electronic appliance provided by the diagnostic server, wherein the diagnostic server analyzes the uploaded at least one transient and steady current signature of the electronic appliance, wherein the diagnostic server reports the diagnosed health status of said at least one electronic appliance; and
a display device adapted to display the reported diagnosed health status of said at least one electronic appliances, wherein the display device is adapted to display fetched contact details of a service center of the at least one electronic appliances to a user.

22. The system as claimed in claim 21, wherein the diagnostic server further comprise an analytical engine running on the diagnostic server, the analytical engine adapted to analyze the uploaded at least one transient and steady current signature of the at least one electronic appliance and diagnose the health status of said at least one electronic appliance based on the analyzed at least one transient and steady current signature of the at least one electronic appliance

23. The system as claimed in claim 21, wherein the at least one electronic appliance further comprises at least one of: an air conditioner, a washing machine, a refrigerator, a television, and a microwave.

24. The system as claimed in claim 21, further comprising a yellow page server adapted to store and provide contact details of the service center of the at least one electronic appliances to the diagnostic server over the Internet.

25. 21, further comprising a database connected with the diagnostic server, the database adapted to store a transient current signature of the at least one transient and steady current signature for the at least one electronic appliances as a reference, wherein the predefined electrical parameters of said at least one electronic appliance and the at least one transient and steady current signature of the electronic appliance are sampled by the home energy gateway.

26. (canceled)
